(19) United States
(12) Patent Application Publication
(10) Pub. No.: US 2023/0378492 A1
(43) Pub. Date: Nov. 23, 2023

(54) FUEL CELL MEMBRANE HUMIDIFIER AND FUEL CELL SYSTEM COMPRISING SAME

(71) Applicant: KOLON INDUSTRIES, INC., Seoul (KR)

(72) Inventors: Hyoung Mo YANG, Seoul (KR); Kyoung Ju KIM, Seoul (KR); Woong Jeon AHN, Seoul (KR); In Ho KIM, Seoul (KR)

(21) Appl. No.: 18/260,263

(22) PCT Filed: Jan. 21, 2022
(86) PCT No.: PCT/KR2022/001148

§ 371 Date: Jul. 3, 2023

(30) Foreign Application Priority Data
Jan. 27, 2021 (KR) 10-2021-0011714
Jan. 27, 2021 (KR) 10-20210011715

(51) Int. Cl. H01M 8/04119

(52) U.S. Cl. CPC H01M 8/04149; H01M 8/04141

(57) ABSTRACT

The present invention relates to a fuel cell membrane humidifier and a fuel cell system comprising same, wherein exhaust gas discharged from a fuel cell stack is introduced into a fuel cell membrane humidifier in both directions, whereby the humidification efficiency can be improved. The fuel cell system according to an embodiment of the present invention comprises: a blower which supplies dry gas; a fuel cell stack; and a fuel cell membrane humidifier which includes a mid-case, a first exhaust gas inlet formed at one surface of the mid-case, a second exhaust gas inlet formed at the other surface of the mid-case, and one exhaust gas outlet formed at the other surface of the mid-case.

### TECHNICAL FIELD

The present invention relates to a fuel cell membrane humidifier capable of improving humidification efficiency by causing an off-gas discharged from a fuel cell stack to flow into the fuel cell membrane humidifier in both directions, and a fuel cell system comprising the same.

### BACKGROUND ART

Fuel cells are power generation cells that produce electricity through coupling between hydrogen and oxygen. The fuel cells have an advantage of being able to continuously produce electricity as long as the hydrogen and the oxygen are supplied, and having the efficiency that is about twice higher than an internal combustion engine because of no heat loss, unlike general chemical cells such as dry batteries or storage batteries.

Further, since chemical energy generated through coupling between the hydrogen and the oxygen is directly converted into electrical energy, emission of pollutants is reduced. Therefore, the fuel cells have an advantage of being environmentally friendly and being able to reduce concerns about resource depletion due to increased energy consumption.

These fuel cells are roughly classified into, for example, a polymer electrolyte membrane fuel cell (PEMFC), a phosphoric acid fuel cell (PAFC), a molten carbonate fuel cell (MCFC), a solid oxide fuel cell (SOFC), and an alkaline fuel cell (AFC) depending on a type of electrolyte used.

These fuel cells fundamentally operate according to the same principle, but have a difference in a type of fuel used, an operating temperature, a catalyst, an electrolyte, or the like. Among the fuel cells, the polymer electrolyte membrane fuel cell (PEMFC) is known to be the most promising not only for small-scale stationary power generation equipment but also for transportation systems because the polymer electrolyte membrane fuel cell operates at a lower temperature than other fuel cells and can be miniaturized due to a high output density.

One of the most important factors in improving the performance of the polymer electrolyte membrane fuel cell (PEMFC) is to maintain moisture content by supplying a certain amount or more of moisture to a polymer electrolyte membrane (or proton exchange membrane: PEM) of a membrane electrode assembly (MEA). This is because the efficiency of power generation is rapidly degraded when the polymer electrolyte membrane is dried.

Examples of a method for humidifying the polymer electrolyte membrane include 1) a bubbler humidification scheme for filling a pressure-resistant container with water and then passing a target gas through a diffuser to supply moisture, 2) a direct injection scheme for calculating a moisture supply amount required for a fuel cell reaction and directly supplying moisture to a gas flow pipe through a solenoid valve, and 3) a humidification membrane scheme for supplying moisture to a fluidized gas layer using a polymer separation membrane.

Among these, the membrane humidification scheme for humidifying a polymer electrolyte membrane by providing water vapor to air supplied to the polymer electrolyte membrane using a membrane that selectively permeates only water vapor contained in an off-gas is advantageous in that a weight and size of a humidifier can be reduced.

A selective permeable membrane used in the membrane humidification scheme is preferably a hollow fiber membrane having a large permeable area per unit volume when a module is formed. That is, when a humidifier is manufactured using hollow fiber membranes, there are advantages that high integration of the hollow fiber membranes with a large contact surface area is possible so that a fuel cell can be sufficiently humidified even with a small capacity, low-cost materials can be used, and moisture and heat contained in an off-gas discharged with a high temperature from the fuel cell can be recovered and can be reused through the humidifier.

FIG. 1 is a view illustrating a fuel cell membrane humidifier and a fuel cell system comprising the same according to the related art.

As illustrated in FIG. 1, the fuel cell system of the related art includes a blower B, a membrane humidifier 10, a fuel cell stack S, and flow paths P1, P2, P3, and P4 that connect these. P1 is a dry gas supply flow path that supplies a dry gas collected in the blower B to the membrane humidifier 10, and P2 is a humidified gas supply flow path that supplies a gas humidified in the membrane humidifier 10 to the fuel cell stack S. P3 is an off-gas supply flow path that supplies an off-gas discharged from the fuel cell stack S to the membrane humidifier 10, and P4 is an off-gas discharge flow path that discharges the off-gas after moisture exchange to the outside.

The membrane humidifier 10 includes a humidification module 11 in which moisture exchange occurs between the dry gas supplied from the blower B and the off-gas (wetting air) discharged from the fuel cell stack S, and caps 12 and 13 coupled to both ends of the humidification module 11.

A dry gas inlet 12a is formed in the cap 12 on the blower B side to supply the dry gas supplied from the blower B to the humidification module 11, and a dry gas outlet 13a is formed in the cap 13 on the stack S side to supply the air humidified by the humidification module 11 to the fuel cell stack S.

The humidification module 11 includes a mid-case 11a having an off-gas inlet 11aa and an off-gas outlet 11ab, and a plurality of hollow fiber membranes 11b in the mid-case 11a. Both ends of a bundle of hollow fiber membranes 11b are fixed to potting portions 11c. The potting portions 11c are generally formed by curing a liquid polymer such as a liquid polyurethane resin through a casting scheme.

The dry gas supplied from the blower B flows along hollows of the hollow fiber membranes 11b. The off-gas flowing into the mid-case 11a through the off-gas inlet 11aa comes into contact with outer surfaces of the hollow fiber membranes 11b, and then, is discharged from the mid-case 11a through the off-gas outlet 11ab. When the off-gas comes into contact with the outer surfaces of the hollow fiber membranes 11b, moisture contained in the off-gas permeates the hollow fiber membranes 11b to humidify the dry gas flowing along the hollows of the hollow fiber membranes 11b.

However, it generally takes a considerable amount of time for the off-gas to flow into the inside through the off-gas inlet 11aa and then be discharged through the off-gas outlet 11ab, Accordingly, in the off-gas flowing into the off-gas inlet 11aa, a concentration of a material to be selectively transmitted through the hollow fiber membrane is initially relatively high, but gradually decreases over time. That is, since the concentration of the material to be transmitted through the hollow fiber membrane gradually decreases as the off-gas flows from the off-gas inlet 11aa to the off-gas outlet 11ab, an amount of material to be transmitted through the hollow fiber membrane disposed on the off-gas outlet 11ab side also gradually decreases, resulting in a decrease in overall efficiency of the fuel cell.

### DISCLOSURE

### Technical Problem

An object of the present invention is to provide a fuel cell membrane humidifier capable of improving humidification efficiency by causing an off-gas discharged from a fuel cell stack to flow into the fuel cell membrane humidifier in both directions, and a fuel cell system comprising the same.

### Technical Solution

A fuel cell membrane humidifier according to an embodiment of the present invention includes

a mid-case; a first off-gas inlet formed on one side of one surface of the mid-case and a second off-gas inlet formed on the other side of the one surface of the mid-case; and a first off-gas outlet formed on one side of the other surface of the mid-case, and an off-gas outlet formed on the other surface of the mid-case.

In the fuel cell membrane humidifier according to the embodiment of the present invention, the first off-gas inlet and the second off-gas inlet may be formed in a direction inclined at a preset angle.

The fuel cell membrane humidifier according to the embodiment of the present invention may include partition walls configured to partition an inner space of the mid-case into a first space and a second space, wherein the first off-gas inlet may be formed in the first space, and the second off-gas inlet may be formed in the second space.

In the fuel cell membrane humidifier according to the embodiment of the present invention, the off-gas outlet may be formed between the first space and the second space.

In the fuel cell membrane humidifier according to the embodiment of the present invention, the off-gas outlet may be formed between the partition walls for partition into the first space and the second space.

A fuel cell system according to an embodiment of the present invention includes

a blower configured to supply a dry gas; a fuel cell stack; and a fuel cell membrane humidifier including a mid-case, a first off-gas inlet formed on one side of one surface of the mid-case, a second off-gas inlet formed on the other side of the one surface of the mid-case, and an off-gas outlet formed on the other surface of the mid-case.

In the fuel cell system according to the embodiment of the present invention, the first off-gas inlet and the second off-gas inlet may be formed in a direction inclined at a preset angle.

The fuel cell system according to the embodiment of the present invention may include partition walls configured to partition an inner space of the mid-case into a first space and a second space, wherein the first off-gas inlet may be formed in the first space, and the second off-gas inlet may be formed in the second space.

In the fuel cell system according to the embodiment of the present invention, the off-gas outlet may be formed between the first space and the second space.

In the fuel cell system according to the embodiment of the present invention, the off-gas outlet may be formed between the partition walls for partition into the first space and the second space.

The fuel cell system according to the embodiment of the present invention may include a humidified gas supply flow path configured to supply a gas humidified in the fuel cell membrane humidifier to the fuel cell stack; an off-gas supply flow path configured to supply the off-gas discharged from the fuel cell stack to the fuel cell membrane humidifier; and a first off-gas branch flow path branched from the off-gas supply flow path and connected to the first off-gas inlet, and a second off-gas branch flow path branched from the off-gas supply flow path and connected to the second off-gas inlet.

The fuel cell system according to the embodiment of the present invention may include a flow adjustment means for adjusting a flow rate of the off-gas to the first off-gas branch flow path and the second off-gas branch flow path, the flow adjustment means being formed between the first off-gas branch flow path and the second off-gas branch flow path.

Other specific matters of implementation examples according to various aspects of the present invention are included in the detailed description below.

### Advantageous Effects

According to an embodiment of the present invention,

since the off-gas flows into the inside in both directions through the off-gas inlets included on both sides of the one side of the mid-case, respectively, and the off-gas flowing into the inside in both the directions flows toward the off-gas outlet formed at the intermediate portion, it is possible to minimize a decrease in concentration of the material to be transmitted through the hollow fiber membrane and improve the overall efficiency of the fuel cell.

Further, since the off-gas flowing into the inside through the inclined off-gas inlets initially flows in the potting portions, and then turns in the potting portions to flow in opposite directions, it is possible to increase a flow time in the humidification module and improve the overall humidification efficiency.

### DESCRIPTION OF DRAWINGS

FIG. 1 is a view illustrating a fuel cell membrane humidifier and a fuel cell system comprising the same according to the related art.

FIG. 2 is a view illustrating a fuel cell membrane humidifier and a fuel cell system comprising the same according to an embodiment of the present invention.

FIG. 3 is a view conceptually illustrating an off-gas flow in the fuel cell membrane humidifier according to the embodiment of the present invention.

FIG. 4 is a view illustrating a fuel cell membrane humidifier and a fuel cell system comprising the same according to another embodiment of the present invention.

FIG. 5 is a view conceptually illustrating an off-gas flow in the fuel cell membrane humidifier according to the other embodiment of the present invention.

### MODE FOR DISCLOSURE

Since various changes may be made to the present invention, which may have several embodiments, specific embodiments will be illustrated and described in detail herein. However, it will be understood that this is not intended to limit the present invention to the specific embodiments, and all changes, equivalents, or substitutions included in the spirit and scope of the present invention are included.

specific embodiments only and are not intended to limit the present invention. The singular expressions “a,” “an” and “the” include the plural expressions, unless the context clearly indicates otherwise. It will be understood that the terms “include” or “have” herein specify the presence of features, numbers, steps, operations, components, parts or combinations thereof described herein, but do not preclude the presence or addition of one or more other features, numbers, steps, operations, components, parts or combinations thereof. Hereinafter, a fuel cell system according to embodiments of the present invention will be described with reference to the drawings.

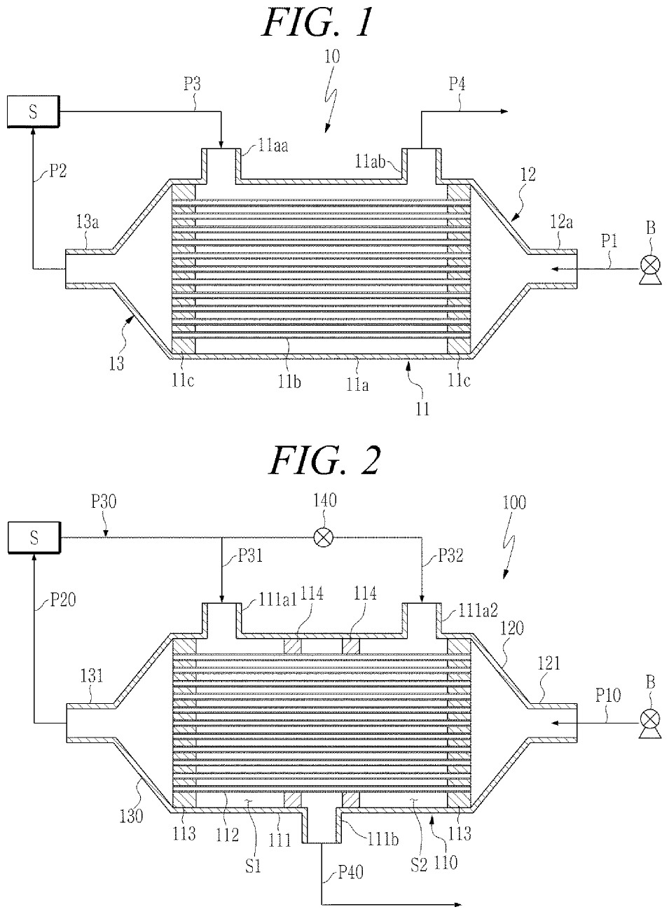

FIG. 2 is a view illustrating a fuel cell membrane humidifier and a fuel cell system comprising the same according to an embodiment of the present invention.

As illustrated in FIG. 2, the fuel cell membrane humidifier and the fuel cell system comprising the same according to the embodiment of the present invention include a blower B, a fuel cell membrane humidifier (100; hereinafter also referred to as a ‘membrane humidifier’), a fuel cell stack S, and flow paths P10, P20, P30, and P40 that connect these.

The blower B collects a gas in an atmosphere and supplies the gas to the membrane humidifier 100. An output magnitude of the blower B may be determined depending on an output magnitude of the fuel cell stack S. Optionally, a filter (not illustrated) that removes fine dust may be installed before the blower B, and a cooler (not illustrated) that cools a dry gas supplied to the membrane humidifier 100 may be installed between the blower B and the membrane humidifier 100.

The membrane humidifier 100 humidifies the dry gas and supplies the dry gas to the fuel cell stack S. The membrane humidifier 100 includes a humidification module 110 that humidifies the dry gas supplied from the blower B with moisture in an off-gas discharged from the fuel cell stack S. Both ends of the humidification module 110 are coupled to caps 120 and 130. The humidification module 110 and the caps 120 and 130 may be separately formed or may be integrally formed.

A dry gas inlet 121 is formed in the cap 120 on the blower B side to supply the dry gas supplied from the blower B to the humidification module 110, and a dry gas outlet 131 is formed in the cap 130 on the stack S side to supply air humidified by the humidification module 110 to the fuel cell stack S.

The dry gas inlet 121 is connected to a dry gas supply flow path P10 that connects the blower B to the membrane humidifier 100, and the dry gas outlet 131 is connected to a humidified gas supply flow path P20 that connects the cap 130 on the fuel cell stack S side to the fuel cell stack S.

The humidification module 110 is a device in which moisture exchange between the dry gas supplied from the blower B and the off-gas occurs, and includes a mid-case 111 having a pair of off-gas inlets 111a1 and 111a2 and an off-gas outlet 111b, and a plurality of hollow fiber membranes 112 accommodated in the mid-case 111. Both ends of a bundle of hollow fiber membranes 112 are fixed to potting portions 113.

Alternatively, the humidification module 110 may include at least one cartridge including the plurality of hollow fiber membranes 112 and the potting portions 113 that fix the hollow fiber membranes 112 to each other. In this case, the hollow fiber membranes 112 and the potting portions 113 may be formed in a separate cartridge case (an inner case). In this case, the hollow fiber membranes 112 may be accommodated in the inner case, and the potting portions 113 may be formed at ends of the inner case. When the humidification module 110 includes the cartridge, a resin layer for fixing the cartridge may be formed between both ends of the cartridge and the mid-case 111, or a gasket assembly for airtight coupling through a mechanical assembly may be further included.

The mid-case 111 and the caps 120 and 130 may be independently formed of hard plastic or metal, and may have a circular or polygonal cross section in a width direction. The “circular” include oval, and the “polygonal” includes polygonal with rounded corners. Examples of the hard plastic may include polycarbonate, polyamide (PA), polyphthalamide (PPA), and polypropylene (PP).

The hollow fiber membranes 112 may include a polymer membrane formed of a polysulfone resin, a polyethersulfone resin, a sulfonated polysulfone resin, a polyvinylidene fluoride (PVDF) resin, a polyacrylonitrile (PAN) resin, a polyimide resin, a polyamideimide resin, a polyesterimide resin, or a mixture of two or more of these, and the potting portions 113 may be formed by curing a liquid resin such as a liquid polyurethane resin through a casting scheme such as deep potting or centrifugal potting.

In the embodiment of the present invention, the off-gas inlets 111a1 and 111a2 may be provided as a pair on both sides of the mid-case 111. The off-gas inlets 111a1 and 111a2 may be included on both sides in a longitudinal direction (a left and right direction in the drawing) of the mid-case 111 on the one side of the mid-case 111. Of course, a plurality of (three or more) off-gas inlets may be included according to a design.

In an embodiment of the present invention, the off-gas inlets 111a1 and 111a2 may be formed in a substantially vertical direction on one surface of the mid-case 111. “Substantially vertical direction” means that a certain range of a design error that occurs at the time of manufacturing is included.

An off-gas discharged from the fuel cell stack S flows into the membrane humidifier 100 through the off-gas supply flow path P30 and the off-gas inlets 111a1 and 111a2. The off-gas supply flow path P30 is branched into a first off-gas branch flow path P31 and a second off-gas branch flow path P32. The off-gas discharged from the fuel cell stack S flows into the pair of off-gas inlets 111a1 and 111a2 while flowing through the off-gas supply flow path P30, the first off-gas branch flow path P31, and the second off-gas branch flow path P32.

If necessary, a flow adjustment means 140 for adjusting a flow rate of the off-gas to the first off-gas branch flow path P31 and the second off-gas branch flow path P32 may be installed between the first off-gas branch flow path P31 and the second off-gas branch flow path P32. The flow adjustment means 140 may be, for example, a valve.

Meanwhile, an inner space of the mid-case 111 may be partitioned into a first space S1 and a second space S2 by partition walls 114. The partition walls 114 can prevent the off-gas flowing into the first off-gas inlet 111a1 from directly flowing into the second off-gas inlet 111a2 by bypassing without performing moisture exchange with the hollow fiber membrane 112.

In an embodiment of the present invention, the off-gas outlet 111b may be connected to the off-gas discharge flow path P40 and formed as a single off-gas outlet on a surface opposite to the surface on which the off-gas inlets 111a1 and 111a2 are formed. For example, when the pair of off-gas inlets 111a1 and 111a2 are formed on an upper surface of the mid-case 111, the off-gas outlet 111b may be formed on a lower surface of the mid-case 111.

Further, the off-gas outlet 111b may be formed between the partition walls 114 for partition into the first space S1 and the second space S2. When the off-gas outlet 111b is formed in the first space S1 or the second space S2, an off-gas flowing into the off-gas inlets 111a1 or 111a2 may be directly discharged to the outside through the off-gas outlet 111b without performing moisture exchange with the hollow fiber membrane 112.

For example, when the off-gas outlet 111b is formed in the first space S1 in FIG. 2, the off-gas flowing into the inside through the first off-gas branch flow path P31 and the first off-gas inlet 111a1 may flow directly to the off-gas outlet 111b without sufficiently exchanging moisture in the first space S1.

Therefore, the off-gas outlet 111b is preferably formed between the first space S1 and the second space S2. The off-gas outlet 111b is preferably formed between the partition walls 114 for partition into the first space S1 and the second space S2.

Next, an off-gas flow in the fuel cell membrane humidifier according to the embodiment of the present invention will be described with reference to FIG. 3. FIG. 3 is a view conceptually illustrating the off-gas flow in the fuel cell membrane humidifier according to the embodiment of the present invention. In FIG. 3, the off-gas flow is shown as flowing while surrounding the outside of the hollow fiber membranes 112, but the off-gas flow is not limited thereto and may flow into a bundle of the hollow fiber membranes 112, which is not illustrated for convenience of description.

The off-gas discharged from the fuel cell stack S flows into the pair of off-gas inlets 111a1 and 111a2 while flowing through the off-gas supply flow path P30, the first off-gas branch flow path P31, and the second off-gas branch flow path P32

The off-gas flowing into the first off-gas branch flow path P31 and the first off-gas inlet 111a1 performs moisture exchange with the hollow fiber membrane 112 to humidify the dry gas while flowing through the first space S1, and the off-gas flowing into the second off-gas branch flow path P32 and the second off-gas inlet 111a2 exchanges moisture with the hollow fiber membrane 112 to humidify the dry gas while flowing in the second space S2.

The off-gas that has performed the moisture exchange in the first space S1 and the second space S2 is discharged to the outside through the off-gas outlet 111b formed between the first space S1 and the second space S2 and the off-gas discharge flow path P40.

According to the related art, it takes a considerable amount of time to flow into the inside through the off-gas inlet 11aa and then be discharged through the off-gas outlet 11ab, and the concentration of the material to be transmitted through the hollow fiber membrane gradually decreases as the off-gas flows from the off-gas inlet 11aa to the off-gas outlet 11ab, and an amount of material to be transmitted through the hollow fiber membrane disposed on the off-gas outlet flab side also gradually decreases, resulting in a decrease in overall efficiency of the fuel cell,

whereas, according to the embodiment of the present invention, since the off-gas flows into the inside in both directions through the off-gas inlets 111a1 and 111a2 included on both the sides of the one side of the mid-case 111, respectively, and the off-gas flowing into the inside in both the directions flows toward the off-gas outlet 111b formed in an intermediate portion, it is possible to minimize a decrease in concentration of the material to be transmitted through the hollow fiber membrane and improve the overall efficiency of the fuel cell.

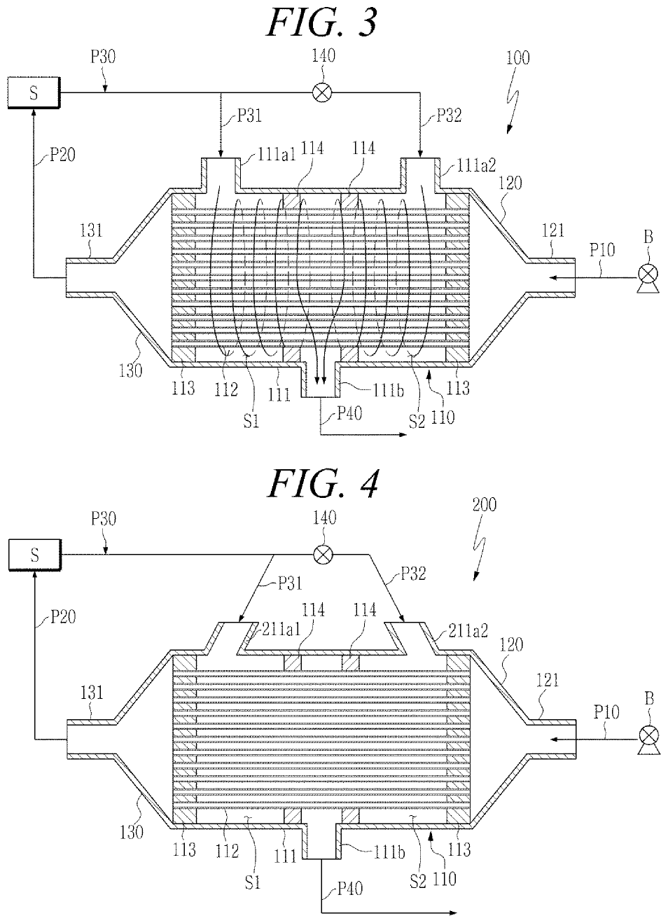

Next, a fuel cell membrane humidifier and a fuel cell system comprising the same according to another embodiment of the present invention will be described with reference to FIG. 4. FIG. 4 is a view illustrating the fuel cell membrane humidifier and the fuel cell system comprising the same according to the other embodiment of the present invention.

Referring to FIG. 4, in the fuel cell membrane humidifier 200 according to the other embodiment of the present invention, inclined off-gas inlets 211a1 and 211a2 may be included as a pair on both sides of a mid-case 111, and the one pair of inclined off-gas inlets 211a1 and 211a2 may be formed in a direction inclined at a preset angle with respect to one surface of the mid-case 111.

More specifically, the inclined off-gas inlets 211a1 and 211a2 are formed so that lower ends of the inclined off-gas inlets 211a1 and 211a2 are inclined toward potting portions 113 so that an off-gas flows toward the potting portions 113.

When the inclined off-gas inlets 211a1 and 211a2 are formed to be inclined toward the potting portions 113, the off-gas flows into the inside while forming an inclination toward the potting portions 113. Therefore, since the off-gas initially flows in the potting portions 113, and then turns in the potting portions 113 to flow in opposite directions, it is possible to increase a flow time in the humidification module 110 and improve the overall humidification efficiency. Of course, a plurality of (three or more) off-gas inlets may be included according to a design.

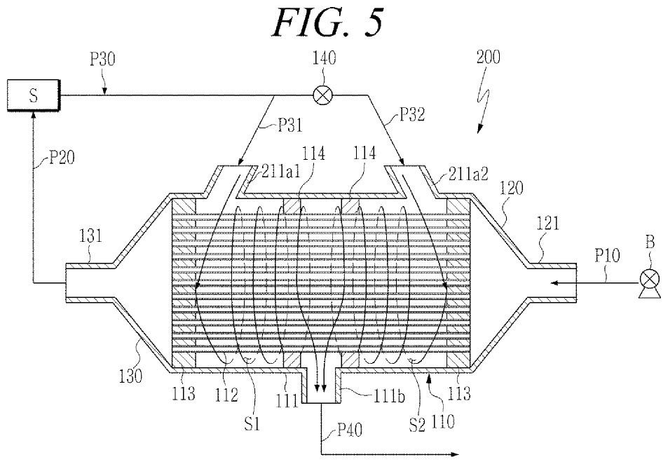

Next, an off-gas flow in the fuel cell membrane humidifier according to the other embodiment of the present invention will be described with reference to FIG. 5. FIG. 5 is a view conceptually illustrating the off-gas flow in a fuel cell membrane humidifier according to the other embodiment of the present invention. In FIG. 5, the off-gas flow is shown as flowing while surrounding the outside of the hollow fiber membranes 112, but the off-gas flow is not limited thereto and may flow into a bundle of the hollow fiber membranes 112, which is not illustrated for convenience of description.

While an off-gas discharged from a fuel cell stack S flows into the pair of inclined off-gas inlets 211a1 and 211a2 while flowing through an off-gas supply flow path P30, a first off-gas branch flow path P31, and a second off-gas branch flow path P32.

The off-gas flowing through the first off-gas branch flow path P31 and the first inclined off-gas inlet 211a1 initially flows in the potting portion 113 in a first space S1, turns in the potting portion 113 to flow in an opposite direction, and performs moisture exchange with the hollow fiber membranes 112 to humidify the dry gas. The off-gas flowing through the second off-gas branch flow path P32 and the second inclined off-gas inlet 211a2 initially flows in the potting portion 113 in a second space S2, turns in the potting portion 113 to flow in an opposite direction, and performs moisture exchange with the hollow fiber membranes 112 to humidify the dry gas.

The off-gas that has performed the moisture exchange in the first space S1 and the second space S2 is discharged to the outside through an off-gas outlet 111b formed between the first space S1 and the second space S2, and an off-gas discharge flow path P40.

According to another embodiment of the present invention, since the off-gas initially flows in the potting portions 113, and then turns in the potting portions 113 to flow in opposite directions, it is possible to increase a flow time in the humidification module 110 and improve the overall humidification efficiency.

Further, since the off-gas flows into the inside in both the directions through the inclined off-gas inlets 211a1 and 211a2 included on both sides of one surface of the mid-case 111, and the off-gas flowing into the inside in both the directions flows toward the off-gas outlet 111b formed at the intermediate portion, it is possible to minimize a decrease in concentration of a material to be transmitted through the hollow fiber membranes and improve the overall efficiency of the fuel cell.

Although the embodiments of the present invention have been described above, those skilled in the art can variously modify or change the present invention through affixation, change, deletion, addition, or the like of components without departing from the spirit of the present invention described in the claims, and this will be said to be also included within the scope of the present invention.

### DETAILED DESCRIPTION OF MAIN ELEMENTS

100: fuel cell membrane humidifier
110: humidification module
111: mid-case
112: hollow fiber membrane
113: potting portion
114: partition wall
111a1, 111a2: off-gas inlet
211a1, 211a2: inclined off-gas inlet
111b: off-gas outlet
B: blower
S: fuel cell stack
P10: dry gas supply flow path
P20: humidified gas supply flow path
P30: off-gas supply flow path
P31: first off-gas branch flow path
P32: second off-gas branch flow path
P40: off-gas discharge flow path

1. A fuel cell membrane humidifier comprising:
a mid-case;
a first off-gas inlet formed on one side of one surface of the mid-case and a second off-gas inlet formed on the other side of the one surface of the mid-case; and
an off-gas outlet formed on the other surface of the mid-case.

2. The fuel cell membrane humidifier of claim 1, wherein the first off-gas inlet and the second off-gas inlet are formed in a direction inclined at a preset angle.

3. The fuel cell membrane humidifier of claim 1, comprising partition walls configured to partition an inner space of the mid-case into a first space and a second space,
wherein the first off-gas inlet is formed in the first space, and the second off-gas inlet is formed in the second space.

4. The fuel cell membrane humidifier of claim 3, wherein the off-gas outlet is formed between the first space and the second space.

5. The fuel cell membrane humidifier of claim 3, wherein the off-gas outlet is formed between the partition walls for partition into the first space and the second space.

6. A fuel cell system comprising:
a blower configured to supply a dry gas;
a fuel cell stack; and
a fuel cell membrane humidifier including a mid-case, a first off-gas inlet formed on one side of one surface of the mid-case, a second off-gas inlet formed on the other side of the one surface of the mid-case, and an off-gas outlet formed on the other surface of the mid-case.

7. The fuel cell system of claim 6, wherein the first off-gas inlet and the second off-gas inlet are formed in a direction inclined at a preset angle.

8. The fuel cell system of claim 6, comprising partition walls configured to partition an inner space of the mid-case into a first space and a second space,
wherein the first off-gas inlet is formed in the first space, and the second off-gas inlet is formed in the second space.

9. The fuel cell system of claim 8, wherein the off-gas outlet is formed between the first space and the second space.

10. The fuel cell system of claim 8, wherein the off-gas outlet is formed between the partition walls for partition into the first space and the second space.

11. The fuel cell system of claim 6, comprising:
a humidified gas supply flow path configured to supply a gas humidified in the fuel cell membrane humidifier to the fuel cell stack;
an off-gas supply flow path configured to supply the off-gas discharged from the fuel cell stack to the fuel cell membrane humidifier; and
a first off-gas branch flow path branched from the off-gas supply flow path and connected to the first off-gas inlet, and a second off-gas branch flow path branched from the off-gas supply flow path and connected to the second off-gas inlet.

12. The fuel cell system of claim 11, comprising a flow adjustment means for adjusting a flow rate of the off-gas to the first off-gas branch flow path and the second off-gas branch flow path, the flow adjustment means being formed between the first off-gas branch flow path and the second off-gas branch flow path.

13. The fuel cell membrane humidifier of claim 1, wherein the humidification module comprise at least one cartridge including a plurality of hollow fiber membranes and a potting portions that fix the hollow fiber membranes to each other.

14. The fuel cell membrane humidifier of claim 13, wherein the hollow fiber membranes formed in an inner case, and the potting portions formed at ends of the inner case.

15. The fuel cell membrane humidifier of claim 14, further comprises a resin layer for fixing the cartridge formed between both ends of the cartridge and the mid-case.

16. The fuel cell membrane humidifier of claim 14, further comprises a gasket assembly for airtight coupling through a mechanical assembly.

17. The fuel cell system of claim 6, wherein the humidification module comprise at least one cartridge including a plurality of hollow fiber membranes and a potting portions that fix the hollow fiber membranes to each other.

18. The fuel cell system of claim 17, wherein the hollow fiber membranes formed in an inner case, and the potting portions formed at ends of the inner case.

19. The fuel cell system of claim 18, further comprises a resin layer for fixing the cartridge formed between both ends of the cartridge and the mid-case.

20. The fuel cell system of claim 18, further comprises a gasket assembly for airtight coupling through a mechanical assembly.
